(19) United States
(12) Patent Application Publication
(10) Pub. No.: US 2008/0070225 A1
(43) Pub. Date: Mar. 20, 2008

(54) System for Supervised Remote Training

(76) Inventors: Daniel P. Vezina, Park City, UT (US); Craig Richard Swapp, Orem, UT (US)

Correspondence Address: GORDON E NELSON;PATENT ATTORNEY, PC, 57 CENTRAL ST, PO BOX 782, ROWLEY, MA, 01969, US

(21) Appl. No.: 11/576,631

(22) PCT Filed: Sep. 15, 2005
(86) PCT No.: PCT/US05/32854

§ 371 Date: Apr. 4, 2007

Related U.S. Application Data
(60) Provisional application No. 60/617,515, filed on Oct. 8, 2004.
(60) Provisional application No. 60/621,752, filed on Oct. 25, 2004.

(51) Int. Cl. G09B 7/00

(52) U.S. Cl. 434/362

(57) ABSTRACT

Techniques for providing expert instruction in interpreting outputs of a test instrument to a student who is at a location remote (103) from the expert. The student makes outputs from the test instrument and an interpretation of the outputs available to an expert (129) via a network (113) and the expert makes a comment available to the student in the same fashion. The outputs, the interpretation, and the comment may be made available in real time or in non-real time. In the non-real-time embodiment, the student makes his interpretation by selecting from menus of possible observations and the expert makes comments in the same fashion. Inputs from the menu selections are stored in a database record and a report is generated from the record. One application of the invention is teaching echocardiography.

### CROSS-REFERENCE TO RELATED APPLICATIONS

This patent application claims priority from two U.S. provisional patent applications having the same title and inventor as the present patent application, U.S. provisional patent application No. 60/617,515, filed Oct. 8, 2004, and U.S. provisional patent application 60,621,752, filed Oct. 25, 2004. Both of these applications are incorporated into the present application by reference for all purposes.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

1. Field of the Invention

The invention relates generally to techniques for providing training remotely and more particularly to providing remote training in the interpretation of outputs from a test instrument.

2. Description of Related Art

Continuing education is always a problem for people in highly-skilled professions. On the one hand, the pace of technological change is such that what one learned in professional school quickly becomes obsolete. On the other hand, the practicing professional simply cannot shut his or her practice down and go back to school for six months or so. One of the solutions to this problem is distance learning, either in its older form of correspondence school or the newer forms offered by the World Wide Web. As long as what is being learned is conceptual, well-designed designed distance learning can be perfectly satisfactory. The current modes of distance learning are, however, far less satisfactory where what is being learned requires “hands on” experience.

An example of training that requires hands on experience is training in echocardiography. Echocardiography is a noninvasive ultrasound echoing technology which permits the echocardiographer to get live and direct images of the heart and the major vessels connected to it. Echocardiography has been used for medical applications for about 40 years. Currently, the technology is mainly used by cardiologists in what we call “echo labs”. These clinical labs study the hearts of patients for diagnostic reasons. Let's pretend that a patient has significant shortness of breath during exercise; the physician needs to know if this problem is caused by pulmonary disease or heart disease (congestive heart failure). Then, the physician can ask for an echo of the heart, and in about 20 minutes the echo physician (echocardiographer) can image the heart structures and evaluate its function. It becomes clear that the diagnostic power of echo is great, painless, fast and scientifically well recognized.

About 20 years ago, this technology was brought into the operating rooms as a monitoring tool for heart function during major surgical procedures including cardiac surgeries. Dr. Michael Cahalan, MD was one of the first physician anesthesiologists to use this technology in the operating room. He was then the Chief of Cardiothoracic Anesthesiology at the University of California in San Francisco (UCSF). In the next few years, the use and advancement of this technology progressed quickly on the cardiology side but not as fast on the anesthesiology side.

Initially (early 1990's), cardiologists fought to keep the technology under their control, but over time the American Society of Echocardiography (ASE) defined the practice of echocardiography as non-specialty based. They defined training criteria and established board certifications for 3 possible pathways: Adult Echocardiography (basically the cardiologist in his echo lab), Pediatric Echocardiography (pediatric cardiologists doing the same thing on pediatric patients) and Perioperative Echocardiography (the MD anesthesiologist in the operating room and ICU setting).

With the birth of Perioperative Echocardiography as a new area of practice, came training guidelines and requirements to be allowed to sit for the Perioperative Echo Board (test). The combination of the appropriate training and the successful completion of the test certified the physician in Perioperative Echocardiography.

As we stand, less than 1% of the 30,000 U.S. anesthesiologists practice echocardiography. From this 1%, very few are actually specifically trained in echocardiography. Additionally, only a few anesthesiology residency training programs offer any kind of training in echo. This means that even the newly trained anesthesiology physicians are not proficient in perioperative echocardiography.

The key point of the American Society of Echo requirements for accepting the training of a physician in echo is that he/she must be supervised for, at least, the first 150 echoes that are performed. This supervision requires that an expert, a trained and certified echo physician review the images and agree or disagree with the other physicians' findings and diagnoses. A consequence of the supervision requirement is that echo training programs are currently residential and fellowship based. To participate in the University of Utah Perioperative Echocardiography fellowship training program, physician anesthesiologists have to stop their practice for one year. The need to stop working to get trained and to compromise one's income is a great burden for the physicians and is a major deterrent to the expansion of echo use in the operating rooms. What is needed is a way of teaching echocardiography which satisfies the American Society of Echo's supervision requirement without requiring that the student leave his or her practice.

### BRIEF SUMMARY OF THE INVENTION

The object of the invention is attained by techniques by which a student may receive supervised instruction in interpreting outputs of a test instrument from a remotely-located expert.

One aspect of the techniques is a method in which the student performs steps via a network of making an output from the test instrument available to the expert, making the student's interpretation of the output available to the expert, and obtaining a comment concerning the interpretation that the expert has made available to the student.

The steps of the method may be performed using a non-real time or a real time mode of interaction between the expert and the student. In the non-real time mode, a computer system that displays a graphical user interface specific to the test instrument may be used to make the report and read the comment. Using the computer system may involve choosing an element of the interpretation from a menu. The method may further include the step of making a document that includes the interpretation and the document may further include the comment.

The method may further be performed using a server to which the student is connected via the network and which is accessible to the expert. In this aspect of the technique, the output is sent to the server, the interpretation is made available on the server, and the comment is attained from the server. The server further provides the graphical user interface used by the student and the expert. Additionally, the interpretation and/or the comment are contained in a queryable database in the server and the interpretation and the comment are obtained by performing a query on the database.

In the real time mode, the steps of making an output available, making an interpretation available, and obtaining a comment are all done using a real-time link between the expert and the student. In one aspect of this mode, the real-time link is provided by a teleconferencing service.

Another aspect of the invention is a method used by an expert of providing supervised instruction in interpreting outputs of a test instrument to a remotely-located student. That method has further aspects similar to the aspects of the method performed by the student.

A further aspect of the invention is apparatus for providing supervised instruction in interpreting outputs of a test instrument from a remotely-located expert. The apparatus is connected via a network to apparatus of the expert and includes output providing apparatus that makes an output of the test instrument available via the network to the expert's apparatus and interpretation apparatus that makes the student's interpretation available via the network to the expert and the expert's comments available via the network to the student.

In a still further aspect, the invention is apparatus whereby supervised instruction in interpreting outputs of an echocardiography machine may be provided to a student by a remotely-located expert. The apparatus includes a server system that is accessible via a network to the student and to the expert, to an echocardiography machine accessible to the student, and to a display for output from the echocardiography machine. The server system includes a first server that receives files from the network and provides them to the network, a second server that provides representations of screens to the network and responds to inputs from screens that are received via the network, storage accessible to the first server for the files, and a database accessible to the second server. The first server receives a copy of the output from the echocardiography machine, places the copy in the storage, and provides the copy to the expert's display. The second server provides a first screen whereby the student can select observations about the copied output from menus in the screen and responds to the screen by setting fields corresponding to the selected observations in a record in the database. The second server further provides a second screen whereby the expert can select comments about the copied output and/or the observations and responds to the second screen setting fields corresponding to the selected comments in the record. The second server additionally responds to an input from a screen specifying that a report be produced by using the record to produce a third screen that displays the report.

Other objects and advantages will be apparent to those skilled in the arts to which the invention pertains upon perusal of the following Detailed Description and drawing, wherein:

### BRIEF DESCRIPTION OF THE SEVERAL VIEWS OF THE DRAWINGS

FIG. 1: General overview of a system for remote training;

FIG. 2: Block diagram of a presently-preferred embodiment of the system for remote training;

FIG. 3: Overview of a GUI page in a preferred embodiment;

FIG. 4: Example study description page;

FIG. 5: Menu system and report terminology table definitions;

FIG. 6: Report data table definition;

FIG. 7: Example generated report;

FIG. 8: Example of a report with a reviewer menu; and

FIG. 9: Details of real-time communication between the echo machine and the study display

### DETAILED DESCRIPTION OF THE INVENTION

The following Detailed description of the invention will first present a conceptual overview of the invention, will then present an overview of a presently-preferred embodiment of the invention and details of the preferred embodiment.

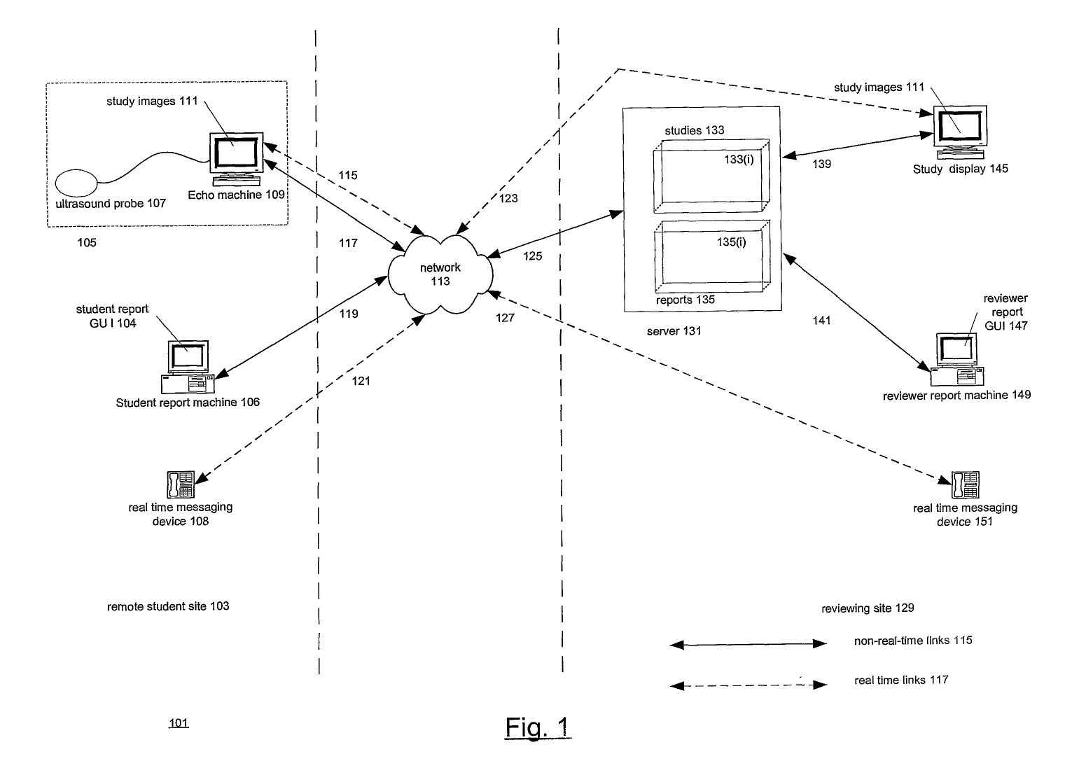

Conceptual Overview of the Invention: FIG. 1

FIG. 1 presents a conceptual overview of a system for remote learning 101. One part of the system is at a remote student site 103; another part of the system is at reviewing site 129; communication between remote student site 103 and teaching site 129 is by means of one or more networks 113. Two kinds of communication are possible via the networks in network 113: non-real-time communication in which there is no guarantee concerning the length of time it will take for a message will arrive and real time communication in which there are such guarantees. The Internet http file protocol is an example of non-real-time communication over a network and a telephone call or a teleconference are examples of real time communication over a network. Links between components of system 101 which provide real time communication are shown with dashed lines, as indicated at 117, while links which provide non-real-time communication are shown with solid lines, as shown at 115.

At remote student site 103 is a test instrument 105 which the student is being taught to use, a machine 106 which the student may use to make a report on output from test instrument 105, and a real time messaging device 108. All of these devices communicate via network 113 with teaching site 129. Test instrument 105 may be any kind of instrument which produces an output which may be stored for later analysis. The stored output from the test instrument is termed in the following a study. In a preferred embodiment, the test instrument is an echocardiograph machine 109 to which is attached an ultrasound probe 107. By inserting ultrasound probe 107 into the esophagus of a patient, images may be made of the beating heart of a patient. The images appear on display 111 of echo machine 109. Echocardiograph machine 109 may also make DICOM files of the images. The DICOM files may be played back at a later time in echocardiograph machine 109, and are thus the studies of the preferred embodiment.

In a preferred embodiment, student report machine 106 is a standard personal computer (PC) which includes a program that provides a student report GUI 104 for machine 106. The student uses the student report GUI to write a report about study images 111. Any other device which provided the student with a GUI to write the report could be used in place of machine 106. Examples would be personal digital assistants and “intelligent” cellular telephones. In other embodiments, echo machine 109 and report machine 106 may share a display or may be a single device that performs the functions of both echo machine 109 and student report machine 106. In the preferred embodiment, real time messaging is done using teleconferencing and a telephone that is made as part of the teleconferencing; the teleconference permits a reviewer at reviewing site 129 and the student to view the output of echo machine 109 simultaneously, permits either the student or the reviewer to control echo machine 109, and permits the student and the reviewer to discuss what they are seeing on echo machine 109 and what to do next with echo machine 109. In other embodiments, the discussion could be done by means of instant messaging systems or Web telephony systems.

Reviewing site 129 has a server 131 which communicates with echo machine 109 and student report machine 106 via network 113. Server 131 executes the network protocols necessary for such communication and further stores studies 133 produced by echo machine 111 and reports 135 which have been produced by students at remote sites 103 and commented on by reviewers at reviewing site 129. Connected to server 131 are study display 145, a device which is able to display images made by echo machine 109 or images produced from a study 133(i), reviewer report machine 149, which is used by a reviewer to review a study stored at 133 or images received directly from echo machine 109, and real time message device 151, in this case a standard telephone. In other embodiments, there may be no server 131 and echo machine 109, study display 145, student report machine 106, and reviewer report machine 149 may communicate directly with each other via network 113. Again, single devices may perform the functions of echo machine 109 and student report machine 106 at remote site 103 and of teacher report machine 149 and study display 145 at reviewer site 129; further, the real time messaging function of device 108 may be incorporated into such a single device or into any of the devices at site 103 and site 129.

System 101 has two modes of operation: a reporting mode and a real-time mode. In the reporting mode, the student at remote student site 103 performs an examination using echo machine 109 on a patient and echo machine 109 creates a DICOM file of the examination. The DICOM file is study 133(i). The student then uses student report machine 106 to write a report 135(i) concerning study 133(i) and sends the study and the report to server 131 via non-real-time links 115 and 119. At reviewing site 129, the reviewer displays study 133(i) on study display 145, writes comments about report 135(i) on reviewer report machine 149, and returns the commented report to the student via non-real-time links 141, 125, and 119.

The real time mode is used when a student needs immediate help while he or she is using echo machine 109 on a patient. In this mode, the student sets up real time links 115, 123, 121, and 127. That done, the student and the reviewer can see what is displayed on echo machine 109 simultaneously, either can control echo machine 109, and both can simultaneously discuss what they are seeing and doing.

As may be seen from the foregoing, all that system 101 really requires to function is non-real-time network connections between the devices used by the student and the reviewer which permit the student to send a study and a report to the reviewer and the reviewer to return the commented study to the student and real-time connections between those devices which permit the reviewer to see the output of test device 105 as it is produced and to discuss what he or she is seeing with the student. In some applications, the ability to control instrument 105 in real time from reviewing site 129 is also useful.

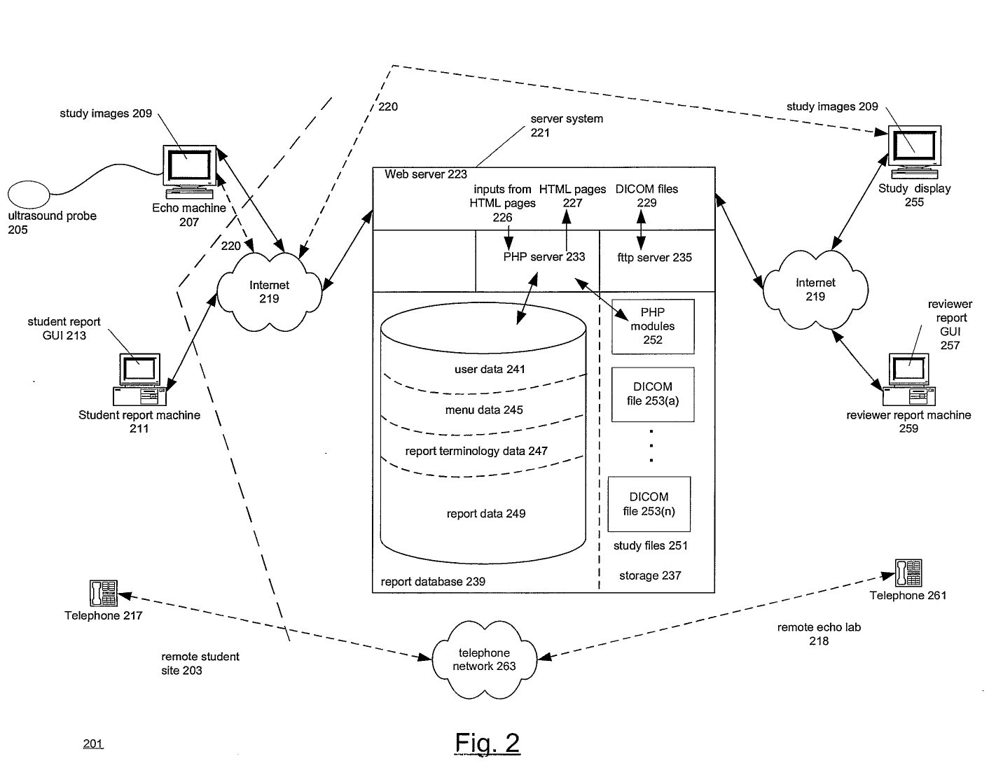

Overview of a Preferred Embodiment of the Invention: FIG. 2

FIG. 2 shows a presently-preferred embodiment 201 of the remote learning system. The student is at remote student site 203; the reviewer at remote echo lab 218. The devices used by the student are echo machine 207 with ultrasound probe 205; the images produced by the echo machine are displayed at 209; the student uses student report machine with student GUI 213 to write reports and read commented reports and uses telephone 217 to discuss the images produced by echo machine 207 in real time. The devices used by the reviewer are study display 255, reviewer report machine 259 with reviewer report GUI 257, and telephone 261.

Also at remote echo lab 218 is server system 221, which includes storage 237. Storage 237 is to be understood to include persistent data storage. Echo machine 207 and student report machine 211 are connected to server system 221 by internet 219, as are study display 255 and reviewer report machine 259. The non-real-time ftp protocol is used to transfer study files 251 echo machine to server 221 and the non-real-time protocol, HTTP is used to transfer HTML pages from server system 221 to student report machine 211 and to receive responses to the HTML pages from the student. HTTP is similarly used to transfer HTML pages from server system 221 to reviewer report machine 259 and to transmit user responses to the HTML GUI back to the server. The real time links use a teleconferencing link 220 to provide the images produced by echo machine 207 via internet 219 to study display 255 as they are produced and to provide control information for echo machine 207 from study display 255. Telephone network 263 and telephones 217 and 261 further provide real time voice communication between student and reviewer. It should be noted here that because the Internet is used for communication between the devices used by the reviewer and server system 221 or echo machine 207, the reviewer may be at a location that is remote to server system 221.

Continuing with server system 221, the system contains one or more processors and memory including persistent memory. Included in server system 221 is code for a Web server 223 that can send and receive IP packets, code for a server 235 for the ftp, file transfer protocol, and code for PHP server 233. Server 235 is used to send and receive DICOM files. PHP server 233 is used to generate the HTML pages 227 sent via the HTTP protocol to GUIs 213 and 257 and to respond to the inputs 226 made to the HTML pages by the student or reviewer. In doing this, PHP server 233 executes PHP modules 252 and performs queries on report database 239. As shown by arrows 227 and 229, web server 223 receives IP protocol packets for servers 233 and 235 and provides the packets to the proper ones of those servers; similarly, servers 233 and 235 provide packets to Web server 223 to be placed on internet 219.

Contained in storage 237 accessible from server system 221 are DICOM study files 251 and report database 239, which contains all of the information needed to generate reports and comments on the reports. As will be explained in more detail later, writing reports and commenting on them is done by examining a study 253(i) and choosing an item from a menu in GUI 213 or GUI 257 that corresponds to what the study appears to show. The menu item specifies the descriptive terminology for what the study appears to show and the report is generated using the descriptive terminology specified by the menu picks.

As would be expected from the above, the information in report database 239 falls into four categories:
User data 241, which contains user information including user identification information, the user's password, and the user's type. In a preferred embodiment, there are three types of users: students, reviewers, and system administrators.
Menu data 245, which contains the data used to create a screen menu which lists the screens used in student report GUI 213 and reviewer report GUI 257.
Report terminology data 247, which contains text associated with menu items used in GUIs 213 and 257. The text includes prompts for the menu items and text that is included in a report when the menu item is selected.
Report data 249: this data relates a student to a study file, to the terminology in terminology data 247 for the report made by the student on the study file, and to the terminology for the comments made by the reviewer on the student's reports. PHP server 233 generates HTML pages for a report and a commented report from report data 249.

Operation in report mode is as follows: After the student has made a study using echo machine 207, he or she sends the DICOM file for the study to server 221, which stores it in study files 251. When the student wishes to do a report on the study, the student logs into the report making and generation system from student report machine 211. GUI 213 takes the student through a sequence of screens from which the student can select the DICOM file 253 he or she wishes to do a report on and then write the report by selecting descriptions of how the study was done and what it shows from report menus on the screens. When a student either submits his or her report menu selections or goes to the next page in the sequence, PHP server 233 responds to the report menu selections by placing indications of the terminology corresponding to the report menu selections in a record for the report in report data 249. When the student or reviewer wishes to see the report, he or she selects a final report screen to which PHP server 233 responds by generating the report from the record in report data 249 and the terminology in report terminology data 247. To comment the report, the reviewer uses reviewer report menus in GUI 257 in the manner just described. PHP server 233 generates a commented report that combines the student report with the comments added by the reviewer. In real time mode, the student sets up a teleconference between echo machine 207 and study display 255 which permits the reviewer to view the output of echo machine 207 in real time on study display 255 and to control echo machine 207 in real time. The student and reviewer use a telephone connection that is set up by the teleconference to discuss what the reviewer and student are doing and seeing.

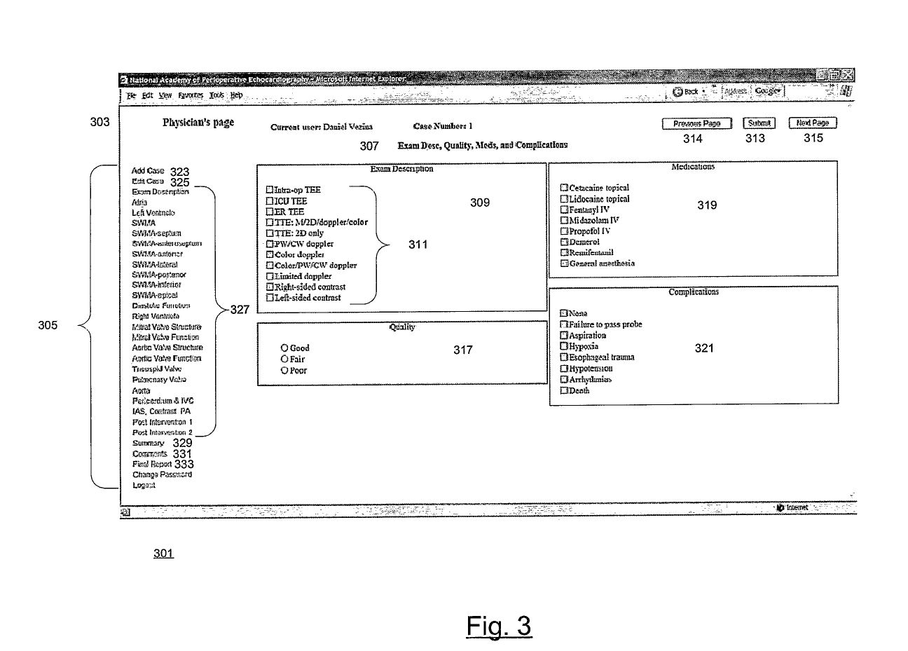

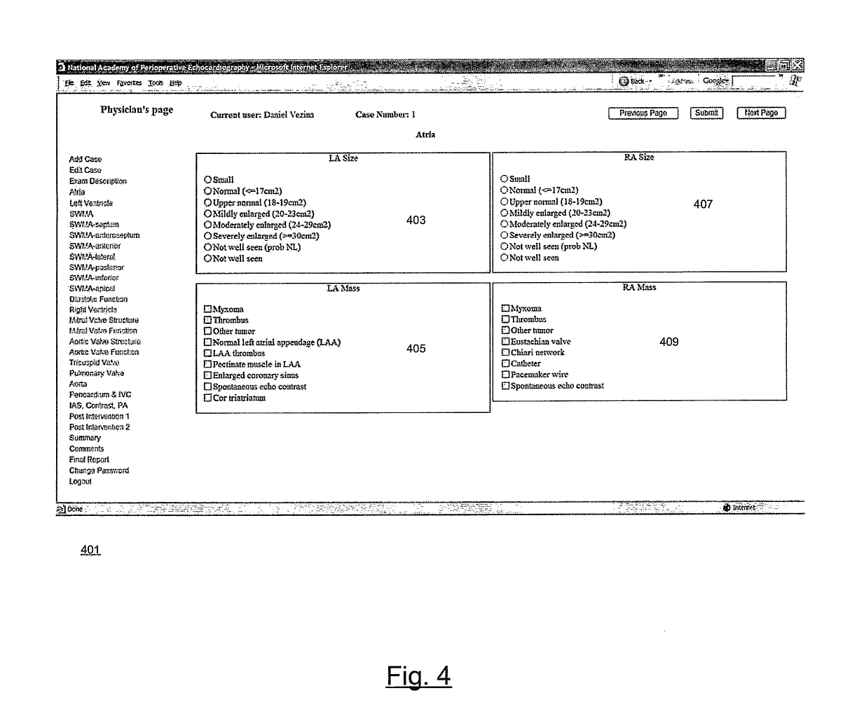

Graphical User Interface 213 in a Preferred Embodiment: FIGS. 3 and 4

FIG. 3 shows a typical screen 301 of GUI 213. Screen 301 is a screen which is used to collect information about the circumstances of the examination. The screen is produced in student report machine 211 from HTML provided by PHP server 233. Each screen has a record in menu data 245. Screen 301 is divided into three distinct sections: The top or header 303 where the user is identified and the submit 313, previous page, and next page 315 navigation buttons are displayed, the left hand side where screen menu 305 of links to other screens is displayed, and the middle section 307 where report menus are displayed.

Links in screen menu 305 which are particularly important in to the present discussion are the following:
Add Case 323, which takes the student to a screen which lets the student specify a DICOM file 253 and a patient which will be the subject of a report;
Edit Case link 325 which lets the student specify an existing report which is to be modified;
report writing links 327, which take the student to the screens which he or she uses to write the report;
Summary ink 329, which takes the student to a summary of the report which is generated by PHP server 233 from the report data 249 for the report and report terminology data 247;
Comments link 331, which takes the student to the reviewer's comments on the report; and
Final Report link 333, to which PHP server 233 responds by generating the report from report data 249 for the report and report terminology data 247.

In system 201, students and patients are related to DICOM files 253 as follows. Each student has a student ID, and when the student downloads a DICOM file 253 from echo machine 207 to server system 221, the student prepends the DICOM file's file name with the student's identifier. In the screen that is navigated to by Add Case link 323, drop-down menus in the screen list the student's patients and the student's DICOM files. The student adds a new report for a selected patient and DICOM file combination to system 201 by selecting from these menus. The new report receives a machine-generated case number. The screen that is navigated to by Edit Case link 325 includes a drop-down list which shows the case numbers for each of the student's reports and the names of the report's patient and the DICOM file for the report's study.

The content specific to the screen includes screen menu 305 and a set of four report menus; at 309 is a report menu 311 that the student can use to indicate the kind of exam given; at 317 is a report menu the student can use to indicate his or her opinion of the exam's quality; at 319 is a report menu the student can use to indicate the medications that had been given the patient prior to the examination; and 321 is a report menu the student can use to indicate complications that occurred during the examination. To select an item in a report menu, the student clicks on the item's check box or radio button.

When the student is satisfied with his or her choices in the report menus and wishes them to become part of the report data 249 for the report, the student clicks on either submit button 313, previous page button 314, or next page button 315. Clicking on the former button causes PHP server 233 to write indications of the menu choices to the report data 249; clicking on the latter button does that and also causes PHP server 233 to provide machine 211 with the next screen in a programmed sequence of screens; clicking on the previous page button causes the PHP server 233 to write indication of the menu choices to the report data 249 and to go back to the previous page in the sequence of pages. If the student wishes to go to another screen without saving the menu choices in report data 249, the student clicks on the screen's link in screen menu 305 and PHP server 233 responds by going to the screen associated with the link.

Header

The software that produces the header area is programmed to consistently show which user mode is currently in effect, which user is logged in, and the case identifier of the case that is being worked on. The software is contained in a single php module in PHP server 233 that is included with other php modules for the report making and generation system. System 201's users and their permissions are stored in user data 241 in the database. When a user logs into the system and is authenticated a php session is created. The user's credentials, permissions, user ID, and name are associated with the session. As each HTML page for a screen is rendered the software goes to the session instance to procure the user's name and permissions to use for display and in the pertinent logic.

The software produces buttons 313, 314, and 315 which have the same appearance on each screen, but whose behavior is dynamically determined at run time. The settings for the buttons in the header are stored in hidden HTML fields. When a button is pressed, javascript responds to the event associated with pressing the button by changing change the value of the next form field so that when the current screen is received by the software that processes the inputs to the current form, that software knows the URL of the previous or next page.

Screen Menu 305

The software that generates screen menu 305 is programmed to take the user's permissions and based off of the permissions retrieve the appropriate menu selections from menu data 245 and dynamically produce menu 305 at run time. In the database is stored the following: 1) the menu position or the numerical order of the prompt, 2) the URL associated with the menu selection, 3) the text which will be displayed on the menu, 4) the permission level associated with the menu item, and 5) whether the menu item is active/inactive. This allows changes to the system that produces screen menu 305 by altering records in menu data 245 rather than changing the software.

saveData.php

All screens are processed by savedata.php. Based on the setting of the nextform field savedata.php can determine the URL for the next screen to be created and sent to the user. saveData.php is called by all of the screens that are sent to the browser. Another hidden HTML field found in each screen is currentForm. The saveData.php module keys off of the currentForm field. Logically saveData.php looks for the value of currentForm which leads to the logic that is specific to the retrieval of data from the screen and proper storage of the retrieved data in report data 249.

Once the proper section of logic within the saveData.php module is found the value of the hidden HTML field isDirty is used to decide whether there is new data on the screen that needs to be processed and stored in report data 249. If isDirty is set to ‘true’ then the logic will retrieve data specifying the items corresponding to the selected menu items, format that data for storage, and save it in the appropriate fields in the records in report data 249.

The report menus are set up so that each report menu item is mapped to a dictionaryNumber and decimalNumber that is specific to the row in report terminology data 247 that contains the information corresponding to the selected menu item. saveData.php saves the dictionaryNumber and decimalNumber corresponding to each selected menu item in a field of the row for the report in report data 249. Each pair of dictionaryNumber and decimalNumber for a given field is concatenated with an underscore, then the pairs, if there is more than one, are concatenated into a comma delimited string, and is stored in the field. Once the data in the form is processed, saveData.php uses the value in nextForm to redirect the browser request to the URL for the next screen that should be produced by PHP server 233 and provided to machine 211.

Generation of Individual Screens

The HTML for the individual screens of GUIs 213 and 257 is generated by the PHP modules 252 that are executed by PHP server 233. Each PHP module 252 has “include” statements that bring in standardized or re-usable code used across all PHP modules 252 that checks to make sure the user has a validated PHP session running. If a session cannot be found then the user will be sent to the login screen. Re-usable code is also included that opens and maintains a database connection during the server side processing of the page. Each page further uses include statements to bring in the aforementioned header, menu, and javascript code, all of which is processed by PHP server 233 to generate and render an HTML page 227 that is sent down to the user's browser on machines 211 and 259.

The content portion of each HTML page 227 makes it unique. The main parts of the content portion are screen menu 305 and the various user interfaces, such as the report menus, that solicit input from the user. The HTML content further includes the hidden HTML fields that hold the settings for the current, previous and next page navigation buttons and the items in the report menus. There is logic in each PHP module which queries report terminology data 247 to obtain the information to generate the HTML page for the user interfaces. The items for each report menu are stored in records that belong to a specific range of values specified by the dictionaryNumber and decimalNumber fields that make up the keys of the records in report terminology data 247; the data returned by the query from report terminology data 247 for each menu item includes the values of the dictionaryNumber and decimalNumber fields and a character string that labels the menu item. The logic found in the PHP modules then acts against the values retrieved from report terminology data table 247 to produce the HTML code to form the requisite radio button, check box, or other GUI structures that comprise the user interfaces that collect data from the user. Internal to this logic is other logic that checks whether the user has already selected and stored data relevant to the current study and the user interface being. If any already selected user interface item is found, then appropriate radio buttons, selection set item, text box, text area, and check boxes are set in the user interface to indicate that the item has been selected and text areas associated with the menu item are populated as required by the selection.

Each page further contains a hidden HTML form variable, isDirty. The purpose of this variable is to keep track of whether input from the user has changed the value of any field within the screen. By default isDirty is set to ‘false’. However, if any field is changed the browser-based event resulting from the change will trigger a javascript routine that will change the setting of isDirty to ‘true’. Once set, even if the changes are reversed the variable will remain set to ‘true’. There is only one instance of isDirty for the entire page, regardless of how many menu items there are in the page.

Actions Involving Link List 305 and Buttons 313, 314, and 315

Although screen menu 305 and buttons 313 and 315 will allow the user to navigate to the same screens within the system and both will find and present any existing screen, there is one difference between the two. Clicking on either submit button 313, previous page button 314, or next page button 315 results in the current screen being processed by saveData.php. Consequently, fields in the record in report data 249 corresponding to the user and the study are set as specified by the report menu selections made by the user. Clicking a link on the menu system, by contrast, results in PHP Server 233 going directly to the screen specified by the link, regardless of the setting of isDirty. Thus, when the user goes directly to the requested screen, any data new entered into the current screen will be lost. Previously-submitted data will not be lost.

Another Example of a Menu Screen: FIG. 4

FIG. 4 shows an example of the screens which the student uses to indicate what he or she sees in the study. As indicated by the title for the screen, the screen permits the student to indicate what the student sees in the left and right atria of the heart. The only difference between screen 301 and screen 401 is that each of report menus 403-409 is for a different aspect of the examination of the left and right atria and contains menu choices for that aspect of the examination. Thus, menu 403 permits the student to indicate the size of the left atrium. Since the atrium can have only one size, the menu is a menu of radio buttons, i.e., only one choice is permitted. Report menu 405, by contrast permits the student to indicate any masses that he or she sees in the left atrium. Since more than one kind of mass may be present, report menu 405 has check boxes instead of radio buttons.

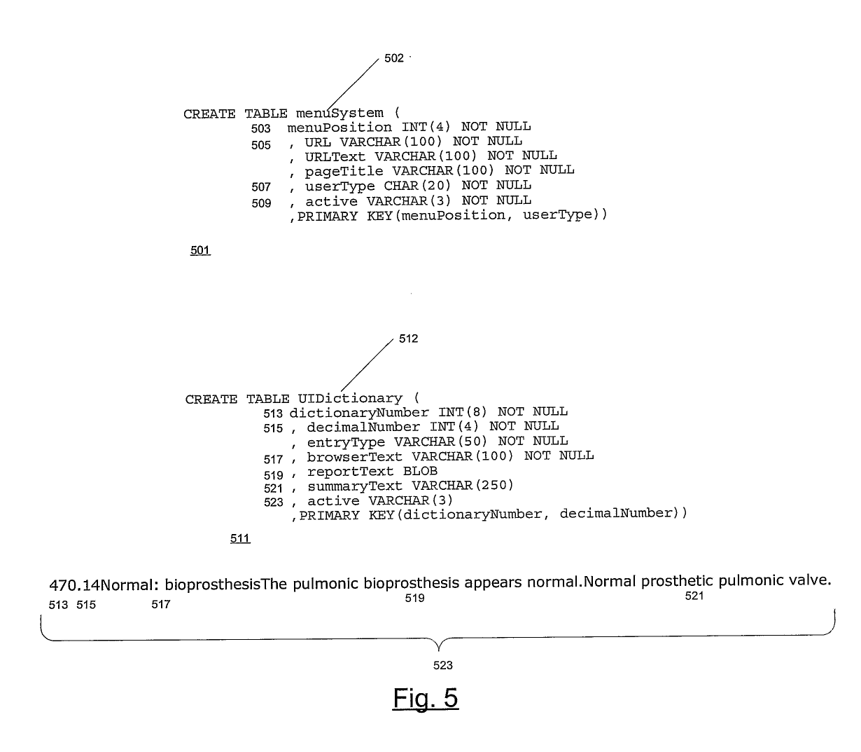

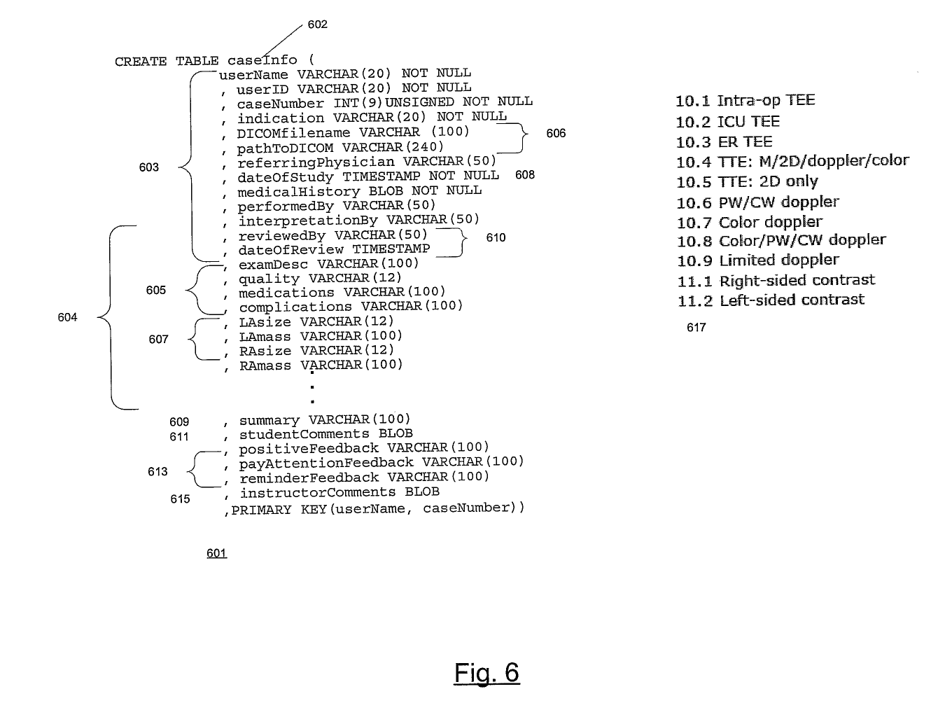

Details of Report Database 239: FIGS. 5 and 6

In a preferred embodiment, menu data 245 is a table called menuSystem which contains a row for each item in screen menu 305 that is used in student report GUI 213, reviewer report GUI 257, and a further GUI (not shown) for the system administrators. Report terminology data 247 is a table called UIDictionary which contains a row for the terminology description corresponding to each report menu item in GUI 211 or GUI 257. FIG. 5 shows the CREATE TABLE statements used to create these tables in SQL.

At 501 is shown the CREATE TABLE statement for menuSystem table 502. The statement lists the table's columns. There is a row in menuSystem table 502 for each item in any of the screen menus 305. Columns of interest in the present context include menuPosition 503, whose value in a row indicates the position of the item corresponding to the row in screen menu 305, URL column 505, whose value in the row indicates the URL of the screen specified by the menu item, userType 507, which indicates the type of user the menu item is intended for, and active 509, which indicates whether the menu item specified by the row is currently being used in system 201.

At 511 is shown the CREATE TABLE statement for UIDictionary table 512. Columns of interest in the present context include dictionaryNumber column 503, whose value in row indicates the dictionary number of the dictionary number-decimal number pair that identifies the terminology description; decimalNumber column 515's values indicate the decimal number of the pair; browserText column 517 contains the text which is to be used in the report menu items which specify the terminology description; reportText column 519 contains the text which appears in the report when a report menu item that specifies the terminology description is selected. summaryText 521 contains a summary of the text which appears in the report which is used to generate a short summary of the report. active column 523, finally, indicates whether the terminology description is currently being used in system 201. An example row from table 512 with reference numbers corresponding to the reference numbers for the columns of the table is shown at 523.

FIG. 6 shows the CREATE TABLE statement for caseInfo table 602, which implements report data 249 in a preferred embodiment. There is a row in caseInfo table 513 for each report that has been made by a given student on a given DICOM file belonging to a given patient as well as a row for each commented report which a reviewer bases on a particular report. As will be explained in more detail in the following, the row for the commented report differs from the row for the report on which it is based in that the row specifies the information added by the reviewer in the comment and has a timestamp which is later than the time stamp on the report.

There are columns in caseInfo table 602 for information related to the study as a whole, for every report menu that appears in either student report GUI 213 or reviewer report GUI 257, for the report summary, for student comments, and for reviewer comments. The contents of fields belonging to the columns are for the most part obvious from their names. The fields containing information related to the study as a whole are shown at 603. Fields of section 603 that are of particular interest in the present context are the fields at 606 which relate the report to the DICOM file 253 for a study, field 608, which is a timestamp that is set when the student sets up a new report, and fields 610, which indicate the reviewer and a timestamp that is set to the current time first time the reviewer edits the commented report. A portion of the columns for the report menus is shown at 604; the columns at 605 are those for the report menus of screen 301; the columns at 607 are those for the report menus of screen 401. Column 609 is for the summary, column 611 is for written student comments, the columns at 613 are for the report menus that appear in reviewer report GUI 257, and column 615 is for written reviewer comments. Fields in the columns at 613 and 615 can be written only by the reviewer.

In the columns for the report menus and for the summary, the information indicated by the menu items selected by the student or the reviewer is indicated by the dictionaryNumber-decimalNumber pair that identifies the record in UIDictionary table 512 that contains the information specified by the menu selection. For example, the dictionaryNumber-decimalNumber pairs for menu 309 are shown at 617; if the student selects both TTE:M/2d/doppler/color and TTE:2D only from menu 311, the examDesc field in section 605 will contain the comma delimited character string “10_{—}4, 10_{—}5”.

Report Generation

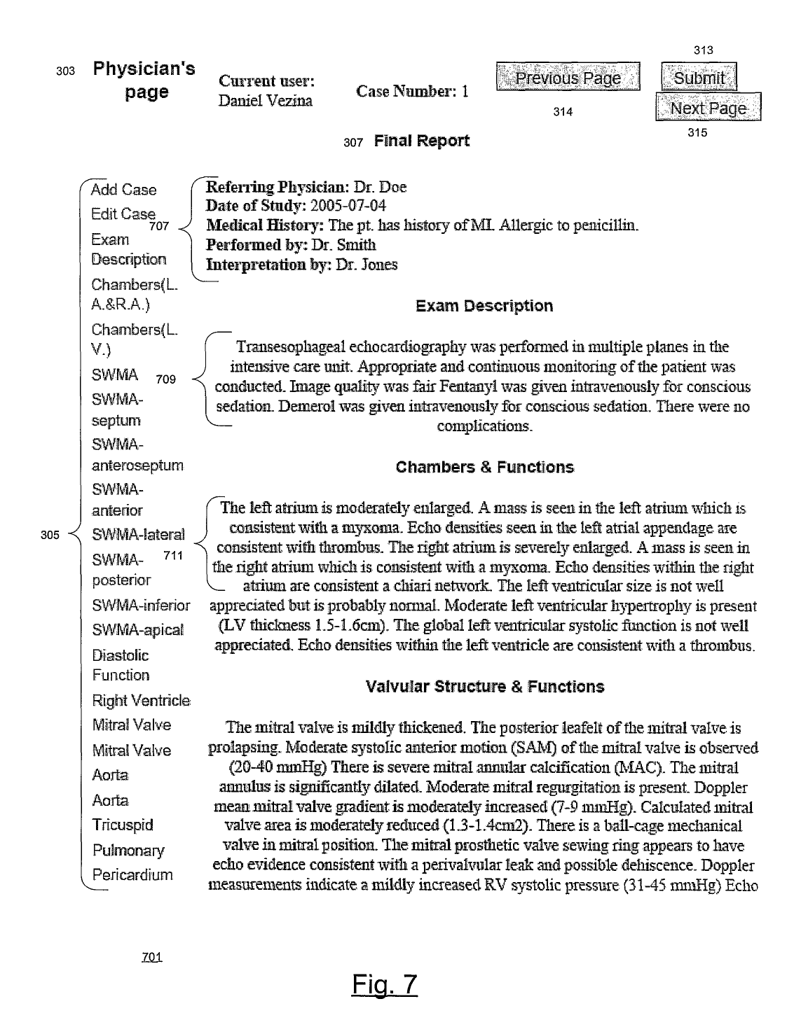

A report goes through two stages:
first, it is a final student report; when the reviewer has added comments, it becomes a final commented report.
   Both stages are generated by PHP server 233 in the same fashion; the difference between them is that at the final student report stage, the row for the report in caseInfo has no data in the fields corresponding to columns 613 and 615. At the final commented report stage, the reviewer has added comments, and there is consequently data in the fields corresponding to those columns.
   Generating a Student Report: FIG. 7

A student can work on any of his or her studies by selecting Edit CASE 325 in screen menu 305 and using the drop-down menus in the Edit Case screen to select the report that he or she wishes to work on and then using the screen menus 305 to navigate to the screen for the part of the study he or she wishes to work on. When the student believes that a report is done, the student selects Final Report menu item 335 in screen menu 305. In response to this selection, PHP server 233 generates an HTML page containing the report from the report's row in caseInfo table 602 and displays the generated page in GUI 213.

FIG. 7 shows a part 701 of a report page. The screen on which report page 701 appears has all of the parts of the screens used generally in GUIs 213 and 257, except that the text of the report appears where otherwise the report menus would appear. The information in the report's text comes directly from the report's row in caseInfo, as may be seen by comparing the contents of the report at 707 with the fields at 603 in the caseInfo record, the contents at 709 with the fields at 605 in the caseInfo record, and the contents at 722 with the fields at 607 in the caseInfo record. To make the parts of the report that are selected from report menus by the student, PHP server 233 queries UIDictionary table 512 using the dictionaryNumber-decimalNumber pairs stored in the caseInfo row corresponding to the report menu selection to locate the rows that correspond to the selected menu items and then outputs the contents of reportText field 519 for those rows to the report.

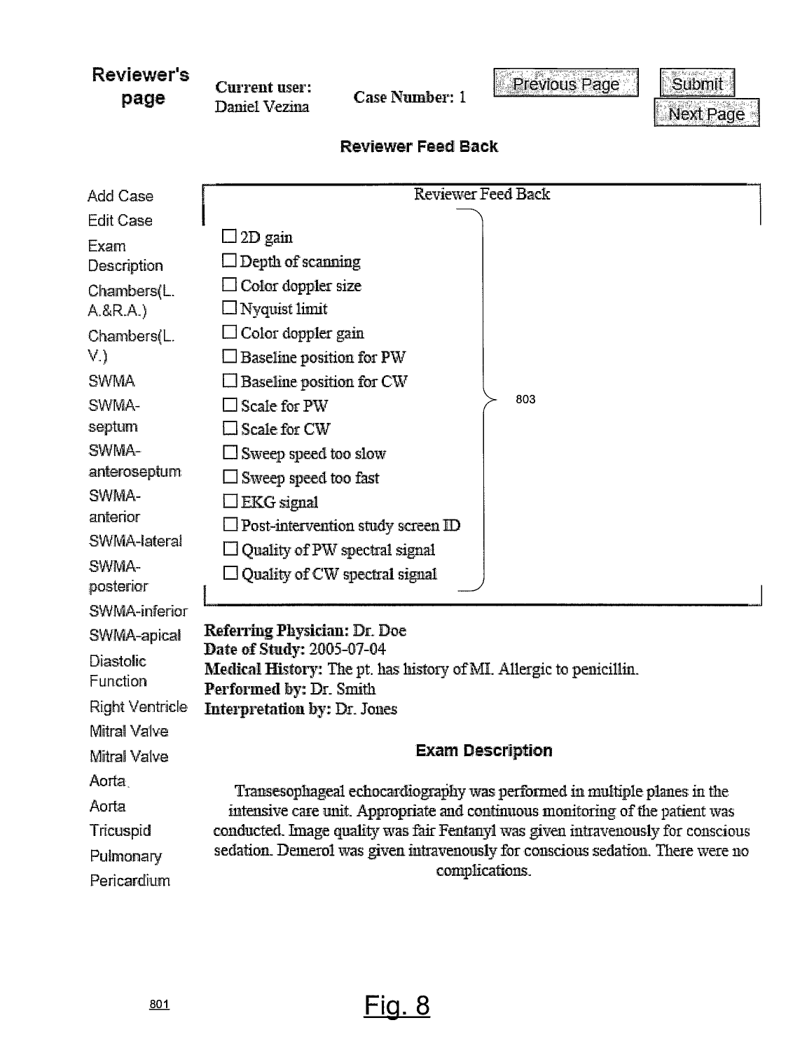

Making a Commented Report: FIG. 8

When the reviewer wishes to make a commented version of a final report submitted by a student, he or she uses the Edit Case menu selection 325, which takes the reviewer to a page which has a drop-down list of the student reports which have been submitted to him/her but not yet commented. When the reviewer selects a student report for commenting from the list, PHP server 233 makes a new row in caseInfo table 602 for the commented report. The new row is a copy of the row for the student report. At the same time the existing record, created by the student, is locked to prevent further changes. The reviewer, but not the student, has access to the new row for editing. All information in both rows will be available to the student and the reviewer via the final commented report.

The reviewer makes the commented report by selecting items from the report menus which provide the data which is stored at 613 in FIG. 6. There are three such reviewer report menus, one which has entries for positive feedback of all kinds, one which has entries for items relating to the way the student is operating echo machine 207, and one which has entries concerning problems with the student's analysis of the study. The text that is to be used for the menu items and is to be included in the report is of course in rows in UIDictionary table 512. When the reviewer clicks on the Submit, Previous Page, or Next Page button, the reviewer report menu selections are written to the corresponding fields 613 in the caseInfo record for the commented report.

FIG. 8 shows reviewer report menu 803 for items relating to the way the student is operating echo machine 207. Menu 803 is superimposed upon the report 801 being commented. In other embodiments, the display may be split into two screens, one of which shows the report and the other of which shows one of the reviewer report menus. In still another embodiment, the reviewer may work with a paper copy of the report and the display may show only the reviewer report menu.

The reviewer can edit the commented report in the same fashion that the student edited the original report; when the reviewer is satisfied with the commented report, the reviewer may notify the student that the commented report is ready. Either the student or the reviewer may use the Final Report menu selection to generate a Web page producing the commented report.

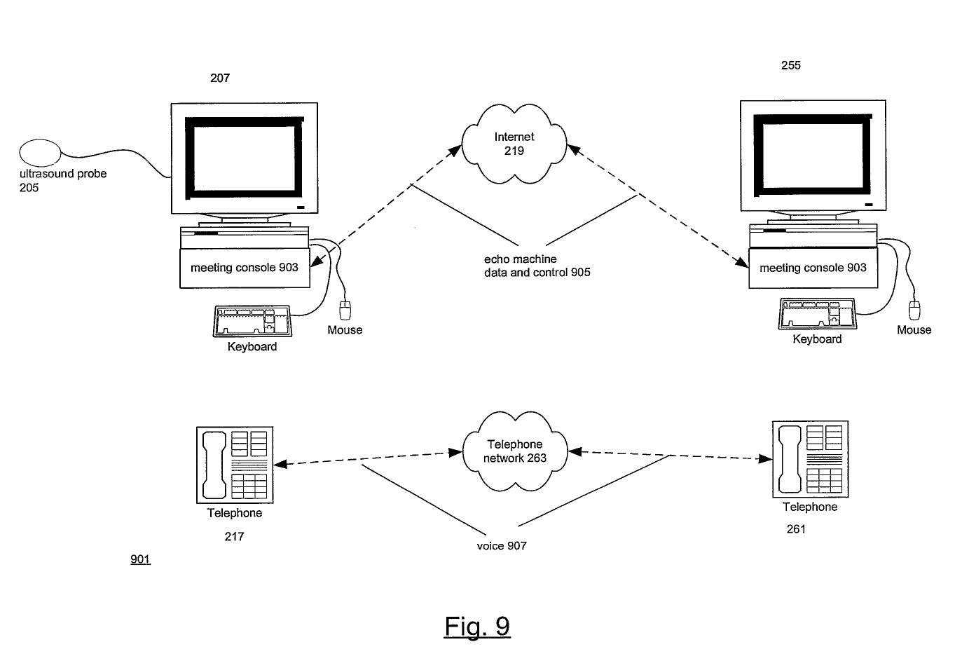

Real Time Analysis of Echo Machine Images: FIG. 9

A feature of system 201 is that it provides the student with the opportunity of consulting with the reviewer in real time during the actual echocardiograhic examination. This feature is particularly important in system 201 because the examinations being performed are being done on actual patients. Consequently, the student must be able to quickly consult a reviewer if he or she encounters something in the examination which he or she does not immediately understand. In system 201, real time consulting is provided by having at least one reviewer present in the remote echo lab at all times and by making it possible for the student to set up a teleconference with the reviewer at any time. In the teleconference, the reviewer may not only see the images being produced by echo machine 207 as they are produced on study display 255, but may also use the mouse and keyboard of study display 255 to control echo machine 207 in exactly the same way as if the reviewer were controlling echo machine 207 from its own.

FIG. 9 shows a presently-preferred implementation of the real-time mode in system 201. As shown at 901, echo machine 207 at student site 203 is connected via the Internet to study display machine 255. Both machines have meeting console software 903, which handles inputs to and outputs from echo machine 207 and study display machine 255. The inputs are received from and the outputs are output to Internet 219. Discussions between the student and the reviewer take place via telephones 217 and 251 and voice network 263.

Set up of the teleconference is handled by a teleconference hosting service which runs on a Web server in Internet 219. The hosting service may be run by a hosting company or it may be provided by the entity doing the training. In the latter case, the hosting service might run in server system 221. The exact way in which the set up is done will depend on the hosting service. In a hosting service which is presently available under the service mark “conferenceplace” set up is done by the student using a plugin provided by conferenceplace in his email program to send an email to the remote echo lab requesting a teleconference. The plugin sends the email to conferenceplace, which sets up real time link 220 between echo machine 207 and study display 255 and the phone link between student site 203 and echo lab 218 and then sends email inviting the student and the reviewer to participate. When responses have been received from both, conferenceplace activates real time link 220 and the phone link. During the teleconference, the output of echo machine 207 is simultaneously visible on both echo machine 207 and study display 255 and echo machine 207 may be controlled by mouse and keyboard inputs from either machine. For example, if the reviewer uses the mouse and cursor to point out a feature on the DICOM image, both the reviewer and the student will see the same image and the cursor in the same position on both machines.

### CONCLUSION

The foregoing Detailed description has disclosed to those skilled in the relevant technologies how to make and use the inventive techniques whereby an expert may provide supervised instruction in interpreting outputs of a test instrument to a remotely-located student and has disclosed the best modes presently known to the inventors of how to practice the technologies. It will, however, be immediately obvious to those skilled in the relevant technologies that there are many other presently-available ways of implementing the techniques and that still other ways will become available in the future.

The presently-preferred embodiment is a client-server implementation of the invention; however, peer-to-peer implementations are also possible, In such implementations, the information that is necessary to the techniques of the invention would pass via the network directly from the students test instrument and report-writing device to the expert's devices and vice-versa. Further, the Internet protocols used in the preferred embodiment may be replaced by future protocols and the HTML pages used to produce the screens may be replaced by pages written in other markup languages, for example XML. Similarly, in the preferred embodiment, the real time links are implemented by means of teleconferencing protocols; in other embodiments, other ways of providing and receiving data in real time may be employed. Further, the devices used by the student and the expert should be viewed functionally; for example, a workstation that has an echocardiography program may be able to serve both as echo machine 207 and as student report machine 211, and the case would be the same with any test instrument which is able to use a computer as an output device.

In the preferred embodiment, the information that is used to produce the report is stored in a database and the DICOM files are stored in a file system; in other embodiments, the DICOM files may be stored as objects in the database, In other embodiments, there may be no database and XML documents may be used to store the information needed for the reports. In still other embodiments, what is stored in the database may be an XML document from which a report may be generated.

For all of the foregoing reasons, the Detailed Description is to be regarded as being in all respects exemplary and not restrictive, and the breadth of the invention disclosed here in is to be determined not from the Detailed Description, but rather from the claims as interpreted with the full breadth permitted by the patent laws.

1. A method whereby a student receives supervised instruction in interpreting outputs of a test instrument from a remotely-located expert,
the method comprising the steps performed by the student via a network of:
making an output available to the expert;
making an interpretation by the student of the output available to the expert; and
obtaining a comment concerning the interpretation that the expert has made available to the student.

2. The method set forth in claim 1 wherein:
the method steps are performed using a non-real-time mode of interaction between the expert and the student.

3. The method set forth in claim 2 further comprising the step of:
using a computing system that displays a graphical user interface specific to the test instrument to make the interpretation.

4. The method set forth in claim 3 further comprising the step of:
using the computer system with the graphical user interface specific to the test instrument to read the comment.

5. The method set forth in claim 3 wherein
the graphical user interface includes a menu; and
the step of using the computer system to make the interpretation includes the step of:
choosing an element of the interpretation from the menu.

6. The method set forth in claim 1 further comprising the step of:
making a document that includes the interpretation.

7. The method set forth in claim 1 further comprising the step of:
making a document that includes the interpretation and the comment.

8. The method set forth in claim 1 wherein
the student is connected via the network to a server which is accessible to the expert; and
the step of making the output available to the expert comprises the step of:
sending the output to the server via the network;
the step of making an interpretation available to the expert comprises the step of making the interpretation available on the server; and
the step of obtaining a comment comprises the step of obtaining the comment from the server.

9. The method set forth in claim 8 wherein
the student is connected to the server via a client of the server; and
the method further comprises the step of using a graphical user interface provided by the server to the client, the graphical user interface being specific to the test instrument, to make the interpretation.

10. The method set forth in claim 8 wherein
the interpretation is contained in a queryable database in the server; and
the method further comprises the step of performing a query on the database to obtain the interpretation

11. The method set forth in claim 10 wherein:
the queryable database further contains the comment; and
the method further comprises the step of performing a query on the database to obtain the comment.

12. A method a method used by an expert of providing supervised instruction in interpreting outputs of a test instrument to a remotely-located student,
the method comprising the steps performed by the expert via a network of:
obtaining an output of the test instrument which the student has made available to the expert;
obtaining the student's interpretation of the output, the student having made the output available to the expert; and
making a comment concerning the student's interpretation available to the student.

13. Apparatus for providing supervised instruction in interpreting outputs of a test instrument from a remotely-located expert, the apparatus being connected via a network to apparatus belonging to the expert and comprising:
output providing apparatus that makes an output of the test instrument available via the network to the expert's apparatus;
interpretation apparatus that makes the student's interpretation available via the network to the expert and the expert's comments available via the network to the student.

14. Apparatus whereby supervised instruction in interpreting outputs of an echocardiography machine may be provided to a student by a remotely-located expert,
the apparatus comprising:
a server system that is accessible via a network to the student and the expert, to an echocardiography machine accessible to the student, and to a display for output from the echocardiography machine accessible to the expert,
the server system including
a first server that receives files from the network and provides files to the network;
a second server that provides representations of screens to the network and responds to inputs from screens received in the network;
storage accessible to the first server for the files; and
a database accessible to the second server that contains information needed to make the screens,
the first server receiving a copy of the output from the electrocardiography machine, placing the copy in the storage, and providing the copy to the expert's display, and the second server providing a first screen whereby the student can select observations about the copied output from menus in the screen and responding to the first screen by setting fields corresponding to the selected observations in the record, providing a second screen whereby the expert can select comments about the copied output and or the report and responding to the second screen by setting fields corresponding to the selected comments in the record, the second server further responding to an input from a screen specifying that the report be produced by using the record to produce a third screen that contains the report.
